(19) United States
(12) Patent Application Publication
(10) Pub. No.: US 2010/0330462 A1
(43) Pub. Date: Dec. 30, 2010

(54) CORROSION RESISTANT MOLDED GRAPHITE PLATES FOR HIGHLY CORROSIVE ELECTROCHEMICAL DEVICES

(75) Inventors: Qinbai Fan, Chicago, IL (US); Renxuan Liu, Chicago, IL (US); Ronald Stanis, Des Plaines, IL (US)

Correspondence Address: MARK E. FEJER;GAS TECHNOLOGY INSTITUTE, 1700 SOUTH MOUNT PROSPECT ROAD, DES PLAINES, IL, 60018, US

(73) Assignee: GAS TECHNOLOGY INSTITUTE, Des Plaines, IL (US)

(21) Appl. No.: 12/491,265

(22) Filed: Jun. 25, 2009

(51) Int. Cl. H01M 2/16; C04B 35/00

(52) U.S. Cl. 429/530; 264/105

(57) ABSTRACT

A graphite plate for electrochemical devices produced from a mixture of solid thermosetting ether-based epoxy resin particles and graphite particles compression molded at room temperature and heated to a temperature greater than about 200° C.

### BACKGROUND OF THE INVENTION

1. Field of the Invention

This invention relates to corrosion resistant molded graphite plates for highly corrosive electrochemical devices. This invention further relates to a method for producing corrosion resistant molded graphite plates for highly corrosive electrochemical devices. Highly corrosive electrochemical device environments include pure phosphoric acid at temperatures as high as 200° C., 20 to 50% sulfuric acid solution, solutions containing up to 4 M V⁵⁺ and V²⁺, and solutions containing high concentrations of KOH and NaOH.

2. Description of Related Art

Graphite plates for use in electrochemical devices and methods for producing such graphite plates are well known. See, for example, U.S. Pat. No. 5,942,347 which teaches composition and process conditions for the compression molding of composite, gas impermeable graphite bi-polar separator plates for polymer electrolyte membrane fuel cells. The composite graphite materials used as separator plates in polymer electrolyte membrane fuel cells have low corrosion rates and high electrical conductivity, but only under certain conditions. For example, when exposed to acidic conditions, the strength of the plates declines over time; and when exposed to a 1M KOH solution, the plates collapse altogether. Thus, there is a need for graphite plates which are resistant to the corrosive effects of highly corrosive electrochemical device environments.

### SUMMARY OF THE INVENTION

It is one object of this invention to provide a graphite plate suitable for use in highly corrosive electrochemical device environments.

It is another object of this invention to provide a method for producing a graphite plate suitable for use in highly corrosive electrochemical device environments.

It is yet another object of this invention to provide graphite plates which are highly corrosion resistant, highly conductive, and moldable for use in strong phosphoric acid solutions at temperatures as high as 200° C., strong sulfuric acid solutions, strong base solutions, and strong oxidative and reductive solutions.

It is yet another object of this invention to provide graphite plates which reduce or eliminate shunt current in electrochemical devices due to highly conductive electrolyte or flow reactants.

These and other objects of this invention are addressed by a method for producing a corrosion resistant graphite plate in which particles of a solid thermosetting ether-based epoxy resin are mixed with graphite particles to form a graphite-resin mixture. The graphite-resin mixture is compression molded at room temperature to form a green graphite plate, which is then heated to a temperature greater than about 200° C., forming a dense corrosion resistant graphite plate. As used herein, the term “dense” means a porosity of no greater than about 4%. The graphite plate of this invention is highly corrosion resistant, highly conductive, and suitable for use in strong phosphoric acid solutions at temperatures as high as 200° C., strong sulfuric acid solutions, strong base solutions, and strong oxidative and reductive solutions. In addition, the graphite plate of this invention reduces or eliminates shunt current in electrochemical devices resulting from high conductivity electrolyte or flow reactants.

### DETAILED DESCRIPTION OF THE PRESENTLY PREFERRED EMBODIMENTS

Epoxy resins are compounds comprising monomers or short chain polymers with an epoxide group disposed at either end. Most common epoxy resins are produced from a reaction between epichlorohydrin and bisphenol-A. The crux of this invention is the use of solid thermosetting ether-based epoxy resin particles as a binder material in the graphite. As used herein, the term “ether-based epoxy resin” refers to epoxy resins in which the monomers or short chain polymers are connected with the epoxide group by an oxygen atom, i.e. ether bond. Other epoxy resins, such as those comprising carbon-amine nitrogen bonds or ester bonds have good stability in only some environments, inorganic acids and caustics, and organic acids, respectively; however, the epoxy resins of this invention are stable against most organic and inorganic acids as well as caustics. Epoxy resins suitable for use in this invention have the general formula

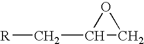

where R is an aryl compound, alkyl, or allyl compounded, which is bonded to said epoxide group by —O—. Exemplary epoxy resins suitable for use in the invention include diglycidyl ether of bisphenol-A, diglycidyl ether of bisphenol-F, glycidyl ether of phenolic novolac, butyl glycidyl ether, and diglicidyl ether of neopentyl glycol. In accordance with one preferred embodiment of this invention, the epoxy resin is diglycidyl ether of bisphenol-A, available from Dow Chemical Company as DOW D.E.R. 661. One of the benefits of this resin is that cross-linking is achieved merely by heating, that is, without the use of a separate liquid curing agent or hardener. However, for other epoxy resins, curing agents or hardeners which are solids may be employed as necessary or desired to provide the required cross-linking. For example, aromatic amines, such as metaphenylene diamine (MPDA), diamino diphenyl sulfone (DDS or DDAS), and diethyltoluene diamine, are widely used to achieve elevated curing temperatures.

In contrast to the epoxy resin employed in the method and apparatus of this invention, phenolic resin, which is a commonly used epoxy resin, is not stable in strong acids and strong bases due to it dangling —OH bond on the benzene ring. The —OH bonds in phenolic resin are not polymerized or reacted and, thus, can react with bases. The phenol is also easy to react with acid at the ortho or para sites on the benzene ring.

Corrosion resistant graphite plates are produced in accordance with the method of this invention by mixing solid epoxy resin particles with graphite particles, compressing the resulting mixture at room temperature, forming a “green” graphite plate, and heating the green graphite plate to a temperature greater than about 200° C., producing a dense, graphite plate which is resistant to corrosion by inorganic and organic acids and caustics, including pure phosphoric acid at temperatures as high as 200° C., 20 to 50% sulfuric acid solution, solutions containing up to 4 M V⁵⁺ and V²⁺, and solutions containing high concentrations of KOH and NaOH. The plate produced in accordance with the method of this invention may be successfully used in high temperature phosphoric acid fuel cells, alkali fuel cells, and reduction-oxidation (Redox) flow batteries with very little shunt current. The plate can also be used in other less corrosive electrochemical devices.

Requirements for composite graphite plates used in electrochemical devices, in addition to corrosion resistance, include high surface and bulk conductivity and low spring back during room temperature pressing. One of the factors affecting conductivity and spring back in composite graphite plates employing epoxy resins is the amount of epoxy resin employed in the graphite-epoxy mixture. For these reasons, in accordance with one embodiment of this invention, the graphite-epoxy mixture employed in the method of this invention comprises about 5% to about 20% by weight epoxy resin. In accordance with one preferred embodiment of this invention, the amount of epoxy resin employed is about 5% by weight of the graphite-epoxy mixture.

One of the factors affecting uniform distribution of the epoxy resin within the graphite plate product is the particle sizes of the graphite and epoxy resin particles. Small graphite particles help the flow of powders under pressing conditions to provide uniform distribution and density. In accordance with one preferred embodiment of this invention, the epoxy resin particles are preferably less than or equal in size to the graphite particles. Because the pressing step occurs before the heating (curing) step, the smaller epoxy resin particle size reduces the amount of spring back after completion of the pressing process. If the epoxy particle size is larger than the graphite particle size, the plate may crack due to spring back after the pressing process. In accordance with one embodiment of this invention, the particle size of the graphite particles is less than about 120 μm. In accordance with one preferred embodiment of this invention, the particle size of the graphite particles is less than about 75 μm.

In accordance with one embodiment of this invention, the graphite plate comprises a center conductive area and a peripheral, circumferential non-conductive area, the latter of which is formed by a mixture of solid epoxy resin particles and particles of at least one non-conductive oxide, such as silica, alumina, or titanium oxide. The non-conductive oxide comprises in a range of about 5% by weight to about 95% by weight of the non-conductive area. The use of a non-conductive oxide for creation of the non-conductive area at the time of production of the graphite plate prevents the epoxy resin from flowing during the heating of the plates, thereby preventing the center conductive area from deforming. By virtue of this arrangement, the resulting plate in the peripheral, circumferential area is not conductive so that conductive electrolytes have no effect (shunt) for the entire electrochemical device.

### Example 1

In this example, one gram of epoxy resin, DOW D.E.R. 661 epoxy resin, which was received in flake form, vibromilled into small powder particles and sieved with a 40 mesh sieve, was mixed with nine grams of graphite flakes from Superior Graphite, Chicago, Ill. (Superior Graphite 2920) and shaken well. The mixture (10% by weight epoxy resin) was placed into a circular die having a diameter of 2.25 inches. The die was then placed in a hydraulic press with a 20,000 pound-force for five minutes, forming a green graphite disc, which is fragile and can easily be bent by hand, and, thus, broken. The green disc was then placed in an oven at 250° C. for half an hour, resulting in a disc which is much stronger and which cannot be easily bent by hand. Epoxy sweat beads were observed forming on the disc surface due to epoxy flowing out of the disc. Measurement of the surface contact resistance showed a surface contact resistance in the range of about 300 to about 500 mOhm.cm.

### Example 2

In this example, 0.5 grams of epoxy resin powder particles were mixed with 9.5 grams of graphite powder in a vibro-mixer for five minutes. The mixture (5% by weight epoxy resin) was placed into a cylindrical die having a diameter of 2.25 inches and subjected to 20,000 pound-force for five minutes. The formed green disc was heat treated at 230° C. for five minutes, producing a disc having a density of 1.77 g/cm³. The contact resistance was measured as about 270 mOhm.cm. The surface of the disc was then sanded, resulting in a measured contact resistance of 190 mOhm.cm. The plates were then tested for stability. During a 72 hour room temperature soaking in V⁵⁺/H₂SO₄ electrolyte, the plates showed excellent stability with no mass loss (actually there was a small mass gain). During three hours of boiling in solutions of 95% H₃PO₄ and 20% H₂SO₄, the plates had small mass gains. For comparison, a piece of a conventional phenolic resin/graphite plate was placed in a beaker with some H₃PO₄. After a few minutes (<10 minutes), the H₃PO₄ solution began to turn a red/purple color. By comparison, the solution containing the graphite plate in accordance with one embodiment of this invention did develop a lighter shade due to the loss of water from the phosphoric acid at 200° C., but only after more than 2 hours. The H₂SO₄ solution remained colorless for the duration of the test at 100° C. After boiling, the plates were rinsed with de-ionized water and dried in an oven at 80° C. for 48 hours. The plate boiled in H₃PO₄ did show some bubbling due to gas escaping from the plate; however, this would not have occurred had the plate been pressed using proper degassing techniques.

### Example 3

In this example, 0.3 grams of epoxy powder particles were mixed with 9.7 grams of graphite powder in a vibro-mixer for five minutes after which the steps performed in Example 2 were carried out. The resulting disc had a density of 1.71 g/cm³ and a surface contact resistance (without sanding) of 235 mOhm.cm.

Table 1 shows the surface contact resistance of composite graphite plates employing different amounts of epoxy resin produced in accordance with the method of this invention compared with some other graphite plates. As shown therein, the graphite plates produced in accordance with the method of this invention, in addition to being strong, have surface contact resistances as low as compatible POCO standard graphite plates for fuel cells (POCO Graphite, Inc., Decatur, Tex.).

TABLE 1
Surface Contact Resistance of Various Graphite Plates

| Sample | R (mOhm · cm) |
|---|---|
| Gold plated surface | 93 |
| POCO surface treated graphite | 390 |
| Graphitestore.com GM-10 grade graphite | 150 |
| 10% Epoxy graphite composite | 420 |
| 5% Epoxy graphite composite | 280 |
| 3% Epoxy graphite composite | 235 |

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

We claim:

1. A method for producing a corrosion resistant graphite plate comprising the steps of:
mixing particles of a solid thermosetting ether-based epoxy resin with graphite particles, forming a graphite-resin mixture;
compression molding said graphite-resin mixture at room temperature, forming a green graphite plate; and
heating said green graphite plate to a temperature greater than about 200° C., forming a dense corrosion resistant graphite plate.

2. The method of claim 1, wherein said solid thermosetting ether-based epoxy resin comprises less than about 20% by weight of said graphite-resin mixture.

3. The method of claim 1, wherein said solid thermosetting ether-based epoxy resin comprises less than about 5% by weight of said graphite-resin mixture.

4. The method of claim 1, wherein said particles of said solid thermosetting ether-based epoxy resin are one of less than and equal in size to said graphite particles.

5. The method of claim 1, wherein said particles of said solid thermosetting ether-based epoxy resin have a particle size one of less than and equal to about 75 μm.

6. The method of claim 1 further comprising forming a peripheral region surrounding said graphite plate comprising additional particles of said solid thermosetting ether-based epoxy resin and non-conductive oxide particles.

7. The method of claim 6, wherein said non-conductive oxide particles comprise in a range of about 5% by weight to about 95% by weight of said peripheral region.

8. The method of claim 6, wherein said non-conductive oxide particles comprise an oxide selected from the group consisting of silica, alumina, titanium oxide, and mixtures thereof.

9. The method of claim 1, wherein a solid curing agent is added to said graphite-resin mixture.

10. A graphite plate for electrochemical devices comprising:
a mixture of solid thermosetting ether-based epoxy resin particles and graphite particles compression molded at room temperature and heated to a temperature greater than about 200° C.

11. The graphite plate of claim 10, wherein said solid thermosetting ether-based epoxy resin particles comprise less than about 20% by weight of said graphite plate.

12. The graphite plate of claim 10, wherein said solid thermosetting ether-based epoxy resin particles comprise less than about 5% by weight of said graphite plate.

13. The graphite plate of claim 10 further comprising a peripheral region comprising a mixture of additional said solid thermosetting ether-based epoxy resin particles and non-conductive oxide particles.

14. The graphite plate of claim 13, wherein said non-conductive oxide particles comprise in a range of about 5% by weight to about 95% by weight of said peripheral region.

15. The graphite plate of claim 13, wherein said non-conductive oxide particles comprise an oxide selected from the group consisting of silica, alumina, titanium oxide, and mixtures thereof.

16. The graphite plate of claim 10, wherein said solid thermosetting ether-based epoxy resin particles are one of less than and equal in size to said graphite particles.

17. The graphite plate of claim 10, wherein said solid thermosetting ether-based epoxy resin particles have a particle size less than about 75 μm.

18. The graphite plate of claim 10, wherein said graphite particles have a particle size less than about 120 μm.
